(19) United States
(12) Patent Application Publication
(10) Pub. No.: US 2014/0114626 A1
(43) Pub. Date: Apr. 24, 2014

(54) METHOD OF CALCULATING NUMERIC MODEL FOR INTERPRETATION OF METAL HYDRIDE TANK

(71) Applicant: KOREA INSTITUTE OF GEOSCIENCE AND MINERAL RESOURCES, Daejeon (KR)

(72) Inventors: Sung-Wook CHO, Daejeon (KR); Han-Jung KWON, Daejeon (KR); Jeong-Hyun YOO, Suncheon-si (KR); Ji-Woong KIM, Incheon (KR); Kyung-Woo YI, Seoul (KR); Sang-Kun O, Seoul (KR)

(73) Assignee: KOREA INSTITUTE OF GEOSCIENCE AND MINERAL RESOURCES, Daejeon (KR)

(21) Appl. No.: 13/900,469

(22) Filed: May 22, 2013

(30) Foreign Application Priority Data
Oct. 19, 2012 (KR) 10-2012-0116603

(51) Int. Cl. G06F 17/50

(52) U.S. Cl. CPC G06F 17/5009
USPC 703/2

(57) ABSTRACT

Disclosed is a method of calculating a numeric model for interpretation of a metal hydride tank. The best possible simpljfied algorithm is applied through a simple measuring process, thereby calculating a numeric model for various metal hydride tank systems storing hydrogen, so that temperature variation depending on the reaction with hydrogen and the reacted. quantity of the hydrogen. are calculated with respect to the various metal hydride tank systems by calculating only the numeric model. The method. includes (a) charging a metal hydride (MH) alloy in a metal hydride tank system under a preset temperature condition, (b) measuring temperature variation and a reaction rate between MH alloy and hydrogen, and concentration of the hydrogen of the MH alloy by supplying or emitting the hydrogen, and (c) calculating a numeric model for the temperature variation, the reaction rate, and the concentration of the hydrogen based on data measured through step (b).

### CROSS-REFERENCE TO RELATED APPLICATION

This application claims the benefit under 35 U.S.A. §119 of Korean Patent Application No. 10-2012-0116603, filed. on Oct. 19, 2012 in the Korean Intellectual Property Office, the entirety of which is incorporated herein by reference.

### BACKGROUND OF THE INVENTION

1. Field of the Invention

The present invention relates to a method of calculating a numeric model for the interpretation of a metal hydride tank. In more particular, the present invention relates to a method or calculating a numeric model for the interpretation of a metal hydride tank, in which temperature variation and reacted quantity of hydrogen occurring when hydrogen is absorbed (emitted) into metal (from metal hydride) are measured and the best possible simplified algorithm is applied based on the measured information, thereby calculating a numeric model for various metal hydride tank systems storjng hydrogen, so that temperature variation depending on the reaction with hydrogen and the reacted quantity of the hydrogen can be calculated with respect to the various metal hydride tank systems by calculating only the numeric model.

2. Description of the Related Art

Hydrogen resources exist plentifully, can be easily transformed to different energy, and have superior advantages as a medium for energy storage, so that the hydrogen is expected as a strong energy source to be substituted for fossil fuel in the future. However, since the hydrogen exists in the phase of gas at the normal temperature and atmospheric pressure, the hydrogen represents the lower energy density per volume and an inconvenient characteristic in storage or transport.

As one of the powerful methods to solve the problem, a hydrogen storage method using metal hydride having a characteristic of representing superior volume storage density and reversibly absorbing and emitting hydrogen around the normal temperature and the atmospheric pressure has been studied and researched. However, the speed that hydrogen is absorbed (emitted) into metal (from the metal) is gradually slowed down due to the heat emission (or heat absorption) followed by the reaction, so that the storage (discharge) efficiency is degraded.

Accordingly, the design for a metal hydride tank having the superior heat transfer structure is important. However, it is difficult to manufacture numerous metal hydride tanks having various shapes in an actual size and analyze the behavior thereof through the experiment. Accordingly, attempts to design a proper metal hydride tank through the calculation based on numeric models have been made. If the relationships between the temperature and the reacted quantity of hydrogen according to the structures of the metal hydride tanks can be previously recognized, metal hydride tanks suitable for conditions repuired by a tank user may be designed. According to the conventional method of calculating the numeric model, with respect to a micro-region, a system grid is constructed, a heat transfer governing equation is calculated, and a reaction flow rate is calculated based on physical properties, such as equilibrium pressures and activation energy, of various materials.

However, according to the modeling based on the physical properties, such as equilibrium pressures and activation energy, of various materials, since calculation formulas and parameters required in the calculation formulas are complex, experimental errors are greatly represented, so that reliability is degraded, or a computation amount is increased. Accordingly, problems are caused in the interpretation efficiency and the practicability.

In addition, the behavior analysis applied to a microscopic scale may have a limitation in the scale of an interpretable system.

As a related art, there is Korean Unexamined Patent Publication No. 10-2007-0013385 (published on Jan. 31, 2007) disclosing a method for measurement of the hydrogen content in metallic hydride for a fuel cell car.

### SUMMARY OF THE INVENTION

An object of the present invention is to provide a method of calculating a numeric model for interpretation of a metal hydride tank, in which the best possible simplified algorithm is applied through a simple measuring process, thereby calculating a numeric model for various metal hydride tank systems storing hydrogen, so that temperature variation and reaction rate depending on the reaction with hydrogen and the reacted quantity of the hydrogen can be calculated with respect to the various metal hydride tank systems by calculating only the numeric model.

In order to accomplish the above object, there is provided a method of calculating a numeric model for the interpretation of a metal hydride tank. The method includes (a) charging a metal hydride (MH) alloy in a metal hydride tank system and maintaining a preset temperature condition, (b) measuring temperature variation obtained depending on heat of reaction between the metal hydride alloy and hydrogen, a reaction rate therebetween, and concentration of the hydrogen contained in the metal hydride alloy by supplying or emitting the hydrogen while varying a content of the hydrogen contained in the metal hydride alloy charged in the metal hydride tank system, and (c) calculating a numeric model for the temperature variation obtained depending on the heat of the reaction, the reaction rate, and the concentration of the hydrogen contained in the metal hydride alloy based on data measured through step (b).

As described above, based on a simple measuring process for a material, temperature variation and reacted quantity of hydrogen occurring when hydrogen is absorbed (emitted) into metal (from metal hydride) are measured, and the best possible simplified algorithm is applied, thereby calculating a numeric model for various metal hydride tank systems storing hydrogen, so that temperature variation and reaction rate depending on the reaction with hydrogen and reacted quantity of the hydrogen can be calculated with respect to the various metal hydride tank systems by calculating only the numeric model.

Therefore, according to the present invention, since the numeric model can be easily calculated with respect to various systems, problems related to the manufacturing cost of a device, the experimental cost of the device, and required time can be overcome.

### BRIEF DESCRIPTION OF THE DRAWINGS

FIG. 1 is a flowchart showing a method of calculating a numeric model for interpretation of a MH tank according to the embodiment of the present invention.

FIG. 2 is a schematic view showing an MM tank system used in the method of calculating the numeric model for interpretation of the metal hydride tank according to the embodiment of the present invention.

FIG. 3 is an expanded schematic view showing an MH storage device of FTG. 2.

FIG. 4 is a schematic view showing the variation in the concentration of in an MH alloy according to the pressure when H₂ is absorbed or emitted.

FIG. 5 is a graph showing a reaction rate measured according to the temperature when H₂ is emitted.

FIG. 6 is a graph showing the relationships among three parameters of a reaction rate, a reaction temperature, and the concentration of H₂ in an MH alloy when H₂ is emitted.

FIG. 7 is a flowchart a process of calculating a numeric model that is defined based on the relationships among three parameters of a reaction rate, a reaction temperature, and the concentration of H₂ in an MM alloy.

### DETAILED DESCRIPTION OF THE INVENTION

The advantages, the features, and schemes of achieving the advantages and features of the present invention will be apparently comprehended by those skilled in the art based on the embodiments, which are detailed later in detail, together with accompanying drawings. The present invention is not limited to the following embodiments but includes various applications and modifications. The embodiments will make the disclosure of the present invention complete, and allow those skilled in the art to completely comprehend the scope of the present invention. The present invention is only defined within the scope of accompanying claims.

Hereinafter, a method of calculating a numeric model for the interpretation of a metal hydride tank according to an exemplary embodiment of the present invention will be described with reference to accompanying drawings.

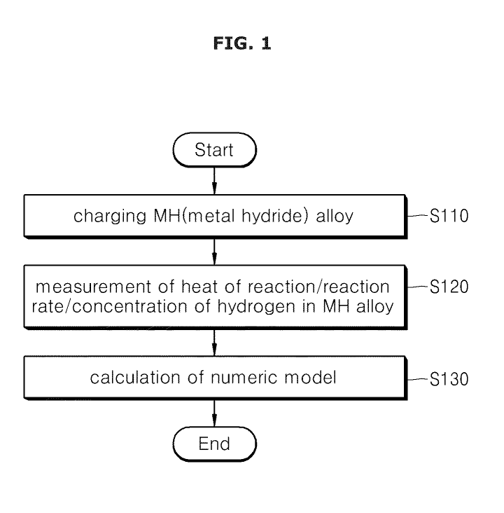

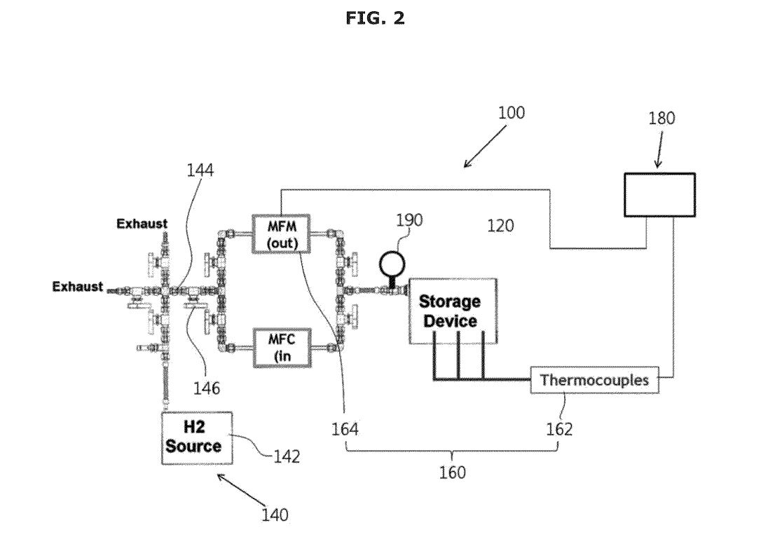

FIG. 1 is a flowchart showing a method of calculating a numeric model for the interpretation of a metal hydride (MH) tank according to the embodiment of the present invention. FIG. 2 is a schematic view showing an MH tank system used in the method of calculating the numeric model for interpretation of the metal hydride tank according to the embodiment of the present invention.

Referring to FIGS. 1 and 2, the method of calculating the numeric model for the interpretation of the metal hydride tank according to the embodiment of the present invention includes a step of charging an MH alloy (step S110), a step of measuring the heat of reaction/reaction rate/the concentration of H₂ in the MH alloy (step S120), and a step of calculating a numeric model (step S130).

Charging MH Alloy

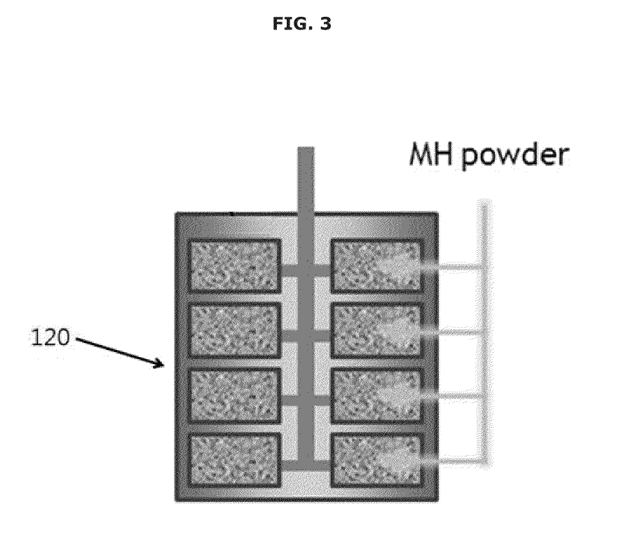

In the step of charging the MH alloy (step S110), the MH alloy is charged in an MH alloy storage device 120 provided in a MH tank system 100 and a preset external temperature condition is maintained. In this case, FIG. 3 is an expanded schematic view showing the MH storage device 120 of FIG. 2.

Referring to FIGS. 2 and 3, the MH tank system 100 includes the MH alloy storage device 120, a hydrogen supply unit 140, an integral measuring unit 160, and a numeric model integral calculating unit 180.

The MH alloy storage device 120 is charged with an MH alloy. In this case, preferably, the MH alloy is prepared in the form of powders. For example, the MH alloy may include a Ti—Cr—V—Fe alloy. In more detail, the MH alloy may include the composition of Ti_{0.32}—Cr_{0.35}—V_{0.25}—Fe_{0.08} (subscript denotes a mole fraction).

The hydrogen supply unit 140 is mounted to supply hydrogen (H₂) to the MH alloy charged in each cell of the MH alloy storage device 120. The hydrogen supply unit 140 may include a hydrogen source 142, a hydrogen supply pipe 144, and a control valve 146.

The hydrogen source 142 supplies hydrogen. The hydrogen supply pipe 144 supplies the hydrogen, which is stored in the hydrogen source 142, to the MH alloy storage device 120. The control valve 146 is mounted on the hydrogen supply pipe 144 to supply hydrogen to the MH alloy storage device 120 or cut off hydrogen.

The integral measuring unit 160 measures the temperature variation depending on the heat of reaction between an MH alloy and hydrogen and a reaction rate therebetween in the process of supplying hydrogen to the MH alloy or emitting the hydrogen from the MH alloy while varying the content of H2 of the MM alloy charged in the MH alloy storage device 120.

The integral measuring unit 160 includes a thermocouple 162 mounted on the MH alloy storage device 120 to measure the temperature variation depending on the heat of reaction, which is generated by the reaction between the MH alloy and hydrogen, and a flow measurement device (MFC (mass flow controller), MFF (mass flow meter)) 164 mounted between the MH alloy storage device 120 and the hydrogen supply unit 140 to measure the flow rate corresponding to the reaction rate between the MH alloy and the hydrogen.

The numeric model integral calculating unit 180 integrally calculates the temperature variation depending on the heat reaction, the reaction rate, and the concentration of hydrogen in the MH alloy based on data measured by the integral measuring unit 160.

In addition, the MH tank system 100 may further include a pressure gauge 190. The pressure gauge 190 is mounted between the MM alloy storage device 120 and the hydrogen supply unit 140 to measure pressure. In this case, the pressure gauge 190 is not essentially required, and may be omitted if necessary.

Measurement of Heat of Reaction/Reaction Rate/Concentration of Hydrogen in MH Alloy

According to the step of measuring the heat of reaction/reaction rate/Concentration of hydrogen in the MM alloy (step S120), the heat of reaction according to the reaction between hydrogen and the MM alloy charged in the MM alloy storage device 120 is measured based on temperatures, and the reaction rate is measured based on a flow rate. In addition, the concentration of hydrogen contained in the MM alloy is calculated by accumulating the flow rate.

In detail, the hydrogen supply unit 140 may include the hydrogen source 142, the hydrogen supply pipe 144, and the control valve 146. In this case, the hydrogen supply unit 140 supplies hydrogen, which is stored in the hydrogen source 142, to the MH alloy storage device 120 through the hydrogen supply pipe 144. The hydrogen supplied from the hydrogen supply unit 140 to the MH alloy storage device 120 may be supplied or cut off through the control valve 146.

In this case, the MH alloy makes exothermic reaction when absorbing hydrogen, and makes endothermic reaction when emitting hydrogen. In other words, since the process of absorbing hydrogen is an exothermic reaction process, the generated heat must be rapidly transferred to the outside. On the contrary, since the process of emitting hydrogen is the endothermic reaction process, heat must be supplied from the outside so that the hydrogen may be stably emitted.

Meanwhile, the reaction temperature and the reaction rate are measured by using the thermocouple 162 and the flow measurement device 164, respectively. In other words, the temperature variation depending on the heat of reaction generated according to the reaction between the MH alloy and hydrogen is measured by using the thermocouple 162, and the reaction rate between the MH alloy and the hydrogen is measured by using the flow measurement device 164 mounted between the MH alloy storage device 120 and the hydrogen supply unit 140.

Calculation of Numeric Model

In the step of calculating the numeric model (step S130), the numeric model for the temperature variation, the reaction rate, and the concentration of hydrogen in the MH alloy is calculated based on data measured in step of measuring the heat of reaction/reaction rate/the concentration of hydrogen in the MH alloy (step S120).

In particular, the inventors of the present invention have been found out the fact that three main parameters are required in order to calculate the numeric model for the behavior of the hydrogen reaction to the MH alloy, as the research result for several years.

First, the temperature may be calculated by designating an alloy as a heat source. In the process of absorbing hydrogen, which makes the exothermic reaction, the heat source has a positive value. In the process of emitting hydrogen, which makes the endothermic reaction, the heat source has a negative value. In this case, the heat of the reaction related the quantity of reacted hydrogen can be measured through an experiment for a sample.

Second, the reaction rate may be regarded as a reaction flow rate, in detail, a reaction flow rate varying with time because the reaction flow rate is determined depending on the rate of the reaction between the MH alloy and hydrogen.

Third, the concentration of hydrogen contained in the MH alloy may be calculated through the accumulation of the reaction flow rate by the lapse of time.

In addition, the reaction rate is decreased as a monotonic function of the temperature variation depending on the heat of the reaction.

In particular, the inventors of the present invention have been found out the fact that the reaction rate is a function of a temperature and the concentration (C_{H2}) of hydrogen contained in the MH alloy as expressed through Equation 1. In addition, the concentration (C_{H2}) of hydrogen contained in the MH alloy may be expressed through Equations 2-1 and 2-2 when hydrogen is emitted and absorbed, respectively.

Reaction flow rate=f(T, C_{H2}) Equation 1

In Equation 1, T and C_{H2} represent the reaction temperature and the concentration (C_{H2}) of hydrogen contained in the MH alloy, respectively.

C_{H2}=Cᵢₙᵢₜᵢₐₗ−[reaction flow rate×time] Equation 2-1

C_{H2}=Cᵢₙᵢₜᵢₐₗ+[reaction flow rate×time] Equation 2-2

Hereinafter, the method of calculating the numeric model for the interpretation of the metal hydride tank according to the embodiment of the present invention will be described in detail.

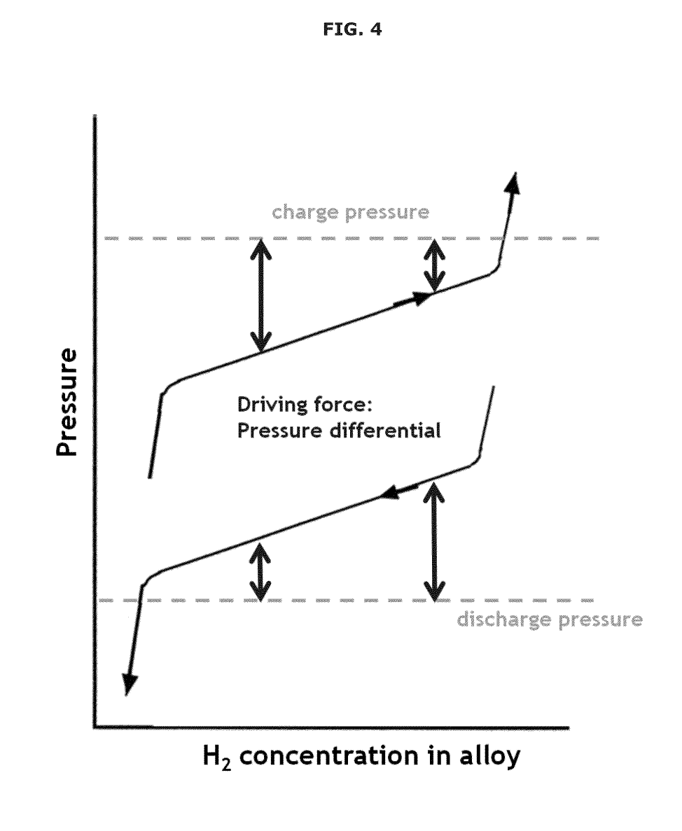

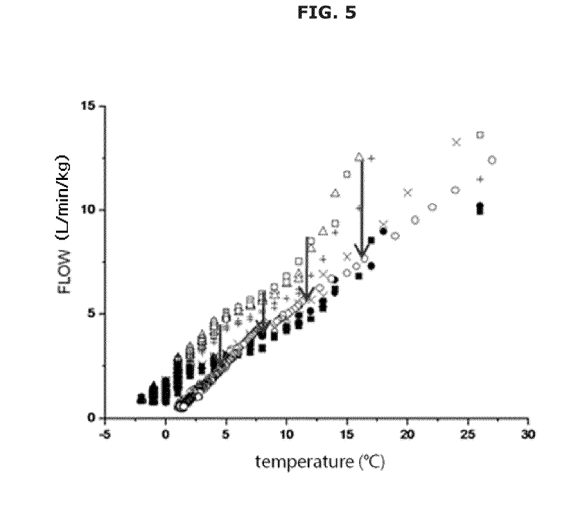

FIG. 4 is a schematic view showing the variation in the concentration of hydrogen contained in the MH alloy according to the pressure when hydrogen is absorbed or emitted at a predetermined temperature. FIG. 5 is a graph showing a reaction rate measured according to the temperature when hydrogen is emitted. When hydrogen is supplied to the MH alloy storage device of the MH tank system described with reference to FIGS. 1 and 2 or discharged from the MH alloy storage device at the atmospheric pressure, the reaction rate and the reaction temperature variation may be measured by using the flow measurement device and the thermocouple, respectively. In this case, the MH alloy includes Ti_{0.32}—Cr_{0.35}—V_{0.25}—Fe_{0.08} (subscript denotes a mole fraction).

As shown in FIG. 5, a proportional curve, in which the reaction flow rate is gradually increased as the reaction temperature is increased when the hydrogen is emitted, is represented.

Meanwhile, as shown in FIG. 4, the concentration of hydrogen contained in the MH alloy varies depending on the pressure. In particular, dotted lines represent a discharge pressure or a charge pressure, and the difference from the dotted lines to the equilibrium pressure is represented. Accordingly, the driving force of reaction varies depending on the difference between the equilibrium pressure and the discharge pressure, or between the equilibrium pressure and the charge pressure based on the concentration of residual hydrogen contained in the MH alloy.

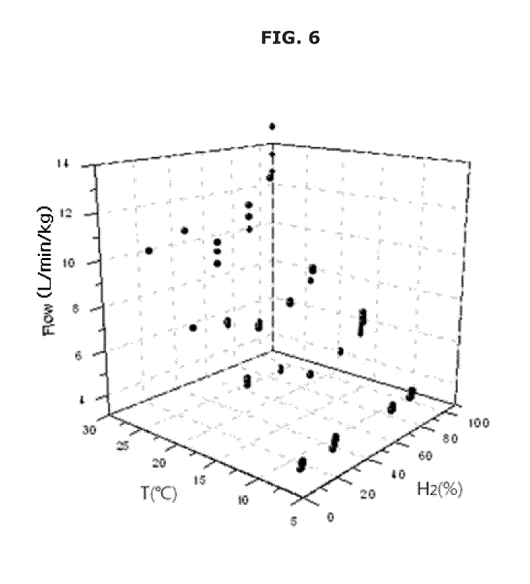

Meanwhile, FIG. 6 is a graph showing the relationships among three parameters of the reaction rate, the reaction temperature, and the concentration of hydrogen contained in the MH alloy varying depending on the reaction time.

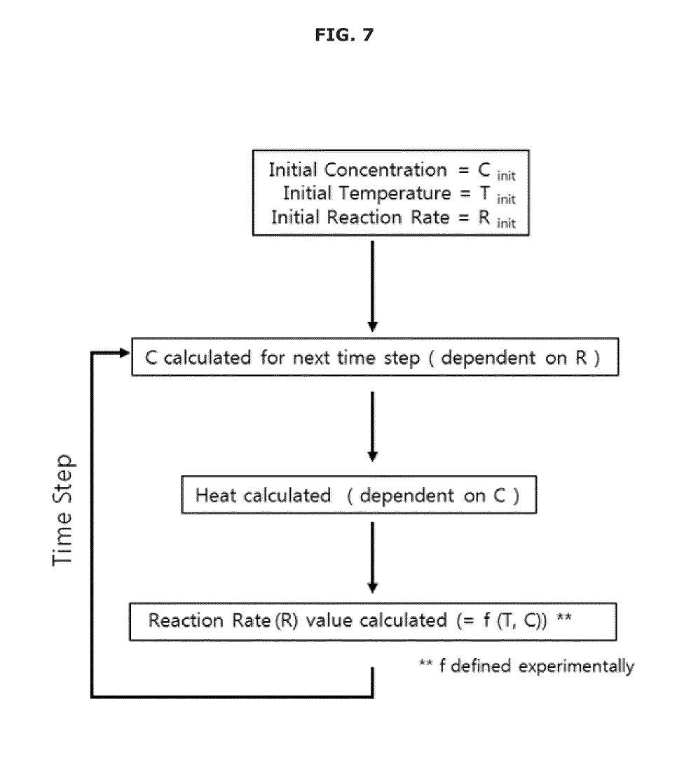

As shown in FIG. 6, the reaction rate may be expressed as the function of the reaction temperature and the concentration of hydrogen contained in the MH alloy. Accordingly, the correlation among the reaction rate, the reaction temperature, and the concentration of hydrogen contained in the MH alloy may be defined, and the above-described algorithm may be completed. In other words, the relationship among three parameters varying depending on the reaction time can be calculated from the flow measurement device of hydrogen expressed as the function of the concentration of hydrogen contained in the MH alloy and the temperature through a numeric model algorithm shown in FIG. 7, so that the interpretation of the MH tank and the desirable design are possible.

As described above, according to the method of calculating the numeric model for the metal hydride tank interpretation, when hydrogen is absorbed (emitted) into metal (from metal hydride), the temperature variation and the reacted quantity of hydrogen are measured, and the best possible simplified algorithm based on the measured information is applied, thereby calculating the temperature variation and the reacted quantity of hydrogen according to the reaction with hydrogen in variously-shaped metal hydride tank systems to store the hydrogen through numeric models therefore.

Therefore, according to the present invention, since the numeric model can be easily calculated with respect to various systems, problems related to the manufacturing cost of a device, the experimental cost of the device, and the required time can be overcome.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A method of calculating a numeric model for interpretation of a metal hydride tank, the method comprising:
(a) charging a metal hydride (MH) alloy in a metal hydride tank system and maintaining a preset temperature condition;
(b) measuring temperature variation obtained depending on heat of reaction between the metal hydride alloy and hydrogen, a reaction rate therebetween, and concentration of hydrogen contained in the metal hydride alloy by supplying or emitting the hydrogen while varying a content of the hydrogen contained in the metal hydride alloy charged in the metal hydride tank system; and
(c) calculating the numeric model for the temperature variation obtained depending on the heat of the reaction, the reaction rate, and the concentration of the hydrogen contained in the metal hydride alloy based on data measured through step (b)
Wherein the rate of reaction between the metal hydride alloy and hydrogen determines a reaction flow rate.

2. The method of claim 1, wherein the metal hydride alloy includes a hydride contajning a titanium (Ti)-chrome (Cr)-vanadium (V)-iron (Fe) alloy.

3. The method of claim 1, wherein the supplying or emitting of the hydrogen in the step (b) is performed by supplying the hydrogen from a hydrogen supply unit, which stores the hydrogen, or emitting the hydrogen from a metal hydride alloy storage device.

4. The method of claim 1, wherein, in the step (b), the temperature variation obtained depending on the heat of the reaction is measured by using a thermocouple, and the reaction rate is measured by a flow measurement device.

5. The method of claim 1, wherein a reaction flow rate satisfies Equation 1,
the reaction flow rate=f(T, C_{H2}), Equation 1
in which T represents a reaction temperature, and C_{H2} represents the concentration of the hydrogen contained in the metal hydride alloy.

6. The method of claim 5, wherein a quantity of residual hydrogen contained in the metal hydride alloy satisfies Equation 2-1 and Equation 2-2,
C_{H2}=Cᵢₙᵢₜᵢₐₗ−[reaction flow rate×time], Equation 2-1
C_{H2}=Cᵢₙᵢₜᵢₐₗ+[reaction flow rate×time]. Equation 2-2

7. The method of claim 1, wherein, in the step (b), the metal hydride alloy makes exothermic reaction when the hydrogen is absorbed, and makes endothermic reaction when the hydrogen is emitted.

8. The method of claim 1, wherein the reaction rate has a relationship of a monotonic function with a reaction temperature.
